(19) United States
(12) Patent Application Publication
(10) Pub. No.: US 2025/0110709 A1
(43) Pub. Date: Apr. 3, 2025

(54) MACHINE LEARNING MODEL FOR GENERATING CODE SNIPPETS AND TEMPLATES

(71) Applicant: Kyndryl, Inc., New York, NY (US)

(72) Inventors: Omar Odibat, Cedar Park, TX (US); Chakkalamattam Jos Paul, Austin, TX (US)

(21) Appl. No.: 18/477,668

(22) Filed: Sep. 29, 2023

(51) Int. Cl. G06F 8/35

(52) U.S. Cl. CPC G06F 8/35

(57) ABSTRACT

Embodiments relate to a machine learning model for generating code snippets and templates. A team feature set for a team is provided to a machine learning model, the team including at least two members. The machine learning model determines a recommendation for the team, the recommendation being related to computer execution to perform a task. In response to determining the recommendation for the team, the recommendation is rendered to the team.

### BACKGROUND

The present invention generally relates to computer systems, and more specifically, to computer-implemented methods, computer systems, and computer program products configured and arranged to provide a machine learning model for generating code snippets and templates.

Software development refers to a set of computer science activities dedicated to the process of creating, designing, deploying, and supporting software. Software itself is the set of instructions or programs that instruct a computer how to function. There are three basic types. System software provides core functions such as operating systems, disk management, utilities, hardware management, and other operational necessities. Programming software gives programmers tools such as text editors, compilers, linkers, debuggers, etc., to create code. Application software (applications or apps) is designed to help users perform tasks. A possible fourth type is embedded software. Embedded systems software is used to control machines and devices not typically considered computers, such as telecommunications networks, cars, industrial robots, and more.

### SUMMARY

Embodiments of the present invention are directed to computer-implemented methods for providing a machine learning model for generating code snippets and templates. A non-limiting computer-implemented method includes providing a team feature set for a team to a machine learning model, the team including at least two members. The method includes determining, using the machine learning model, a recommendation for the team, the recommendation being related to computer execution to perform a task. In response to determining the recommendation for the team, the recommendation is to be rendered to the team.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system configured to automatically provide a machine learning model for recommending or generating code snippets and templates according to one or more embodiments of the present invention;

FIG. 3 is a flowchart of a computer-implemented method for automatically providing and utilizing a machine learning model for generating code snippets and templates for software development teams and for causing display of the code snippets on computer systems of a software development team to resolve a computer problem according to one or more embodiments of the present invention;

FIG. 4 depicts a block diagram of an example overview of providing and utilizing a machine learning model for generating code snippets and templates for software development teams and causing display of the code snippets on computer systems of a software development team to resolve a computer problem according to one or more embodiments of the present invention;

FIG. 5 depicts a block diagram of example features for a team profile for a given team according to one or more embodiments of the present invention;

FIG. 6 depicts a block diagram of example features for team operations for a given team according to one or more embodiments of the present invention;

FIG. 7 depicts a block diagram of example features for team code for a given team according to one or more embodiments of the present invention;

FIG. 8 depicts a block diagram of example features for team historical recommendations for a given team according to one or more embodiments of the present invention;

FIG. 9 depicts a block diagram of example features for team tags for a given team according to one or more embodiments of the present invention;

FIG. 10 depicts a block diagram illustrating further details regarding tag generation according to one or more embodiments of the present invention;

FIG. 11 depicts a block diagram illustrating further details regarding recommendations according to one or more embodiments of the present invention;

FIG. 12 depicts a block diagram of an example graphical user interface rendering recommendations for a given team according to one or more embodiments of the present invention;

FIG. 13 is a flowchart of a computer-implemented method for generating code snippets and templates for software development teams and for causing display of the code snippets on computer systems of a software development team to resolve a computer problem according to one or more embodiments;

FIG. 14 depicts a cloud computing environment according to one or more embodiments of the present invention; and

FIG. 15 depicts abstraction model layers according to one or more embodiments of the present invention.

### DETAILED DESCRIPTION

One or more embodiments automatically provide a machine learning model for generating code snippets and templates. According to one or more embodiments, a learning and explainable system is provided for promoting and tracking the reuse of curated code snippets and best practice templates for architecture design documents.

Large organizations have to ensure that high code quality is utilized to run computer systems and maintain code standardization across multiple software development teams. This also applies for documentation, reference structure, etc. Organizations desire to prevent or avoid software bugs, which cause defects in the software and cause errors in the computer systems executing the software. Additionally, the development of software by a software team can be a tedious process that uses lots of computer resources, and the newly developed software can have bugs.

One or more embodiments are configured to generate recommendations for standard code snippets for software teams assigned to develop software to solve computer problems and/or to generate recommendations for architecture design documents. For standard code snippets, one or more embodiments are configured to automate the identification of the level of reuse per software team and per code pattern. In addition to recommending standard code snippets to the right software team, the recommendations are made at the right time. In order to prevent or avoid software bugs, one or more embodiments are configured promote the reuse of best practice code patterns among different teams, monitor the performance of each software development team, and grade software development teams according to their level of standard code reuse.

Further, one or more embodiments immediately allow new relevant code snippets to be recommended as soon as they are available, for example, as soon as the new code snippets are stored and/or updated in a repository. This improves the quality of the code (up-to-date) of a team that uses the recommended code snippets and reduces the team's efforts in future developments cycles. As can be seen, the recommended code snippet is not simply a replacement/substitute code provided to an individual.

In addition to recommending code snippets, one or more embodiments recommend reference architecture templates including architecture design documents, user experience design, etc. This allows software development teams to know about the reference architecture templates (and documentation) related to a recommended code snippet (i.e., software component). Having the reference architecture templates make it easy to understand the system, write code, and connect sub-components, according to one or more embodiments.

In accordance with one or more embodiments, the recommendations are triggered by many factors, such as feedback from stakeholders for improvements, reported incidents, bugs, etc. This enables the software team to immediately receive recommendations to meet the ongoing system requirements (e.g., stakeholders' feedback, reported incidents, and bugs) without the software team having to actively be working on the code. This solves issues and improves the overall quality of the code and functions of the system in a more efficient way.

One or more embodiments utilize subject matter experts who provide their input to impact the matching between code snippets, for the creation of tags, etc. Subject matter experts provide their input to correct any possible data-driven recommendations and fix the tags in order to ensure high quality recommendations for the future. For example, the system maintains an ontology of tags to prevent any random tags from being included in the similarity calculations. Accordingly, this leads to higher and more reliable recommendations.

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

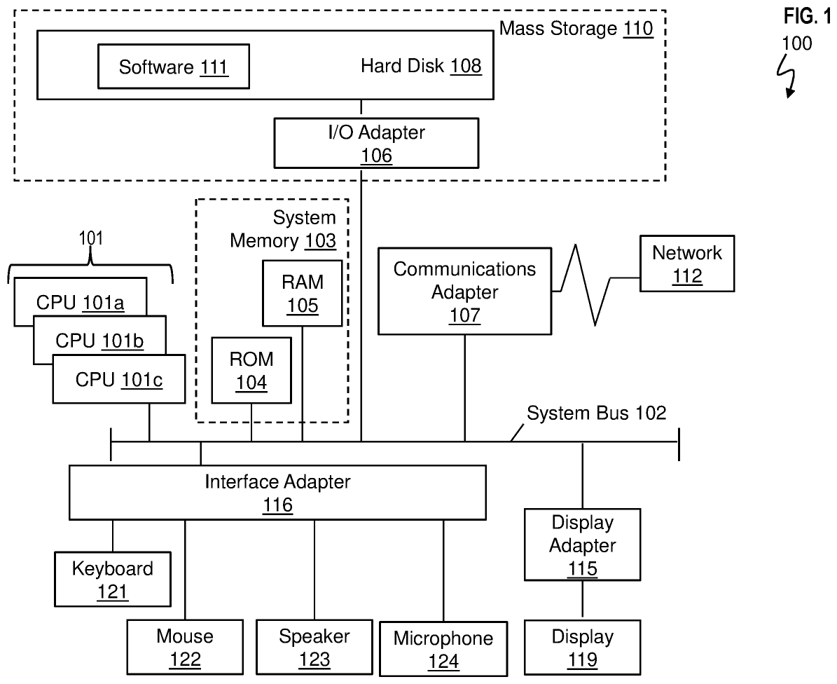

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

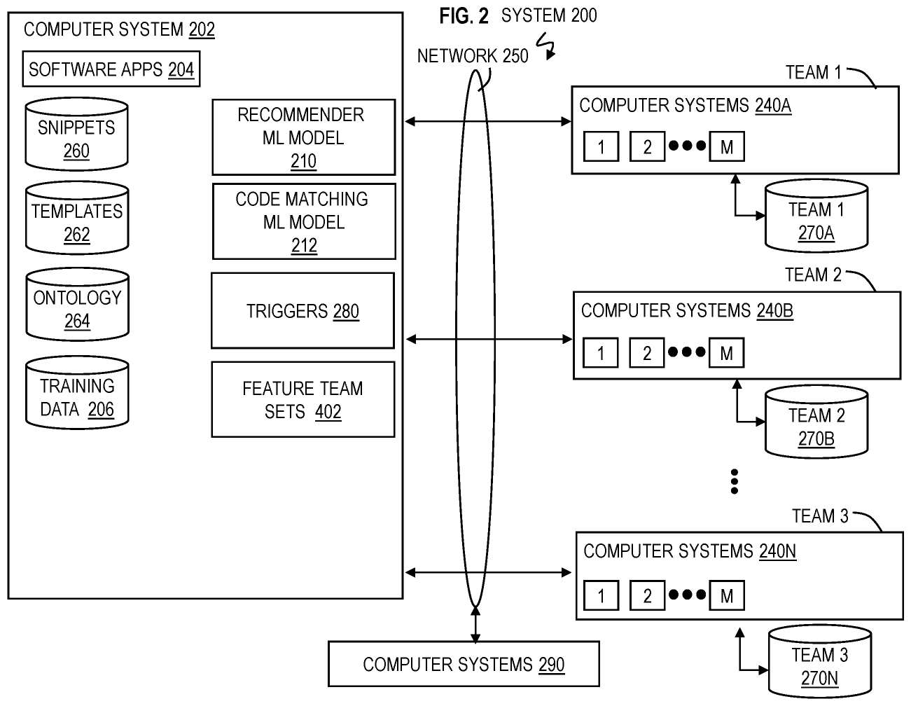

FIG. 2 depicts a block diagram of an example system 200 configured for automatically providing a machine learning model for recommending and/or generating code snippets and templates according to one or more embodiments. The system 200 includes a computer system 202 configured to communicate over a network 250 with many different computer systems, such as numerous computer systems 240A of Team 1 where there can be computer system 1-M respectively for each team member, numerous computer systems 240B of Team 2 where there can be computer system 1-M respectively for each team member, through numerous computer systems 240N of Team 3 where there can be computer system 1-M respectively for each team member. Each team member has his/her own computer system 1, 2, 3, 4, . . . . M. Each team as two or more team members each with their own computer system. The aggregate computer systems 1-M for each team are referred to as computer systems 240A for Team 1, computer systems 240B for Team 2, and the computer systems 240N for Team 3. The computer systems 240A, 240B, through 240N can generally be referred to as computer systems 240 and are utilized to by respective team members of Teams 1, 2, and 3.

For explanation purposes and not limitation, some example scenarios may explicitly refer to Teams 1, 2, and 3. It should be understood that there can be more than three teams. Also, some description may refer to a particular team, such as Team 1, 2, or 3, but it is noted that the description applies by analogy to any of the teams. In large organizations, there are multiple teams such as software engineering teams, software architect teams, user experience (UX) design teams, software database teams, etc. There teams are generally referred to as software development teams, software teams, teams, etc. Various data for each team can be stored in its respective repository. A repository 270A may store data for software development Team 1, a repository 270B may store data for software development Team 2, and a repository 270N may store data for software development Team 3.

The computer systems 240 can include various software and hardware components for software development, testing, implementation, and execution known by one of ordinary skill in the art. The computer system 202, computer systems 240, software applications 204, recommender machine learning model 210, code matching machine learning model 212, computer systems 290, etc., can include functionality and features of the computer system 100 in FIG. 1 including various hardware components and various software applications such as software 111 which can be executed as instructions on one or more processors 101 in order to perform actions according to one or more embodiments of the invention. The software application 204 can include, be integrated with, instruct, and/or call various other pieces of software, algorithms, application programming interfaces (APIs), etc., to operate as discussed herein. The software applications 204 may be representative of numerous software applications designed to work together. The software applications 204 may work with other software in a push and pull communication scheme, client-server communication scheme, etc.

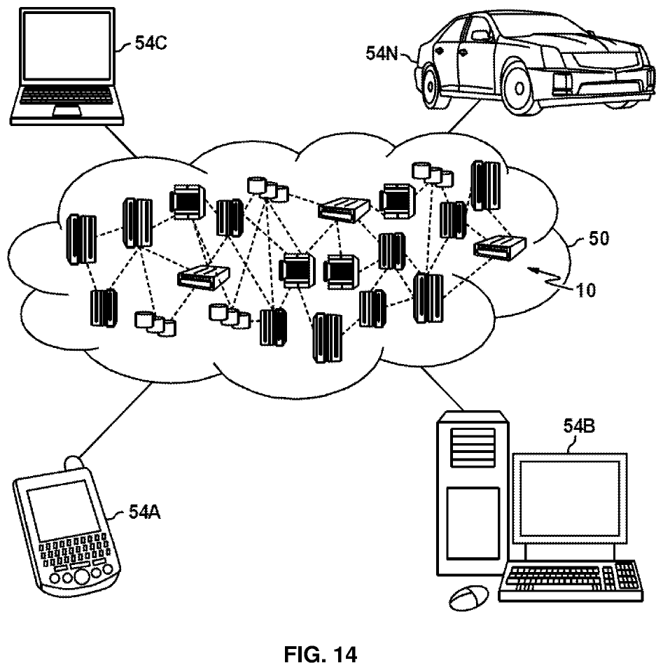

The computer system 202 as well as computer systems 209 may be representative of numerous computer systems and/or distributed computer systems configured to provide services to users of the computer systems 240. The computer system 202 as well as computer systems 209 can be part of a cloud computing environment such as a cloud computing environment 50 depicted in FIG. 14, as discussed further herein. The network 250 can be a wired and/or wireless communication network.

The computer system 202 includes and/or is coupled to a repository 260 of numerous standard code snippets and a repository 262 of numerous reference architecture templates.

A code snippet is a programming term for a small region of reusable source code, machine code, and/or text. Code snippets are formally defined operative units to incorporate into larger programming modules. For example, a code snippet may be software code to execute and accomplish a specific task, such as how to cause a button to change color using a hover event, how to query a database, etc. The code snippets can include many libraries, packages, pieces of code, etc., in one or more software programming languages such as Python®, Java®, C++, etc. The standard code snippets in repository 260 are written by subject matter experts (SME). The code snippets in the repository 260 have already been tested and gone through corner cases that involve operating the software code in extreme situations that occur outside normal operating parameters.

A reference architecture is a document or set of documents that provide recommended structures and integrations of information technology (IT) products and services to form a solution. The reference architecture template embodies accepted industry best practices, typically suggesting the optimal delivery method for specific technologies. A reference architecture template offers IT best practices in a format that guides the implementation of complex technology solutions. The reference architecture templates in the repository 262 include design documents, user experience designs, etc. The reference architecture templates in the repository 262 can have certain guidelines on the design documents, documentation about software components, along with other architecture guidelines that establish how software components relate to one another.

According to one or more embodiments, a system is provided for generating recommendations with explainability to reuse standard code snippets and result architecture reference templates to the relevant documentations (user experience designs, design documents, architecture, etc.) at the team level. For each team such as Teams 1, 2, and 3, the computer system 202 is configured to utilize a comprehensive list of features that drive the recommender machine learning model 210 to identify the most relevant sources at a given point of time. The sources can be a particular code snippet from the repository 260 of standard code snippets and/or a particular reference architecture template from the repository 260 of reference architecture templates. The computer system 202 is configured to perform grading and monitoring to grade software development teams according to their level of standard code reuse and reference architecture template reuse, all while monitoring their performance.

There can be various triggers 280 for initiating the recommender machine learning model 210 on computer system 202. Example triggers 280 to immediately execute the recommender machine learning model 210 can be when there is a new project/ticket/assignment assigned to the team, when there is a new/updated code snippet added to the repository 260, when there is a new/updated reference architecture template added to the repository 262, when stakeholders provide feedback, etc. Further information regarding triggers 280 to execute the recommender machine learning model 210 are provided herein. If a team, for example, Team 1 is assigned a new project or if Team 1 is building a software program, the recommender machine learning model 210 is configured to execute and recommend one or more standard code snippets from the repository 260 and/or recommend one or more reference architecture templates from the repository 262 to assist with the software development work being performed by Team 1. The software applications 204 can cause the recommended standard code snippets and the recommended reference architecture templates to be sent and displayed on the displays 119 of each computer system 1-M of the computer systems 240A of Team 1. Further, the software applications 204 are configured to monitor and track how much or the level at which each of the teams are reusing the recommended code snippets. For example, Team 1 is using the recommended code snippets 90% of the instances they are recommended, Team 2 is using the recommended code snippets 20% of the instances they are recommended, and Team 3 is using the recommended code snippets 10% of the instances they are recommended. Additionally, the software applications 204 can determine the number of times that each particular code snippet in the repository 260 has been recommended and has been reused. For example, the software applications 204 can output and display to the team that a particular code snippet X in the repository 260 has been reused Y number of times (e.g., 10 times) and recommended Z number of times (e.g., 20 times), thereby having a reuse rate of Y/Z.

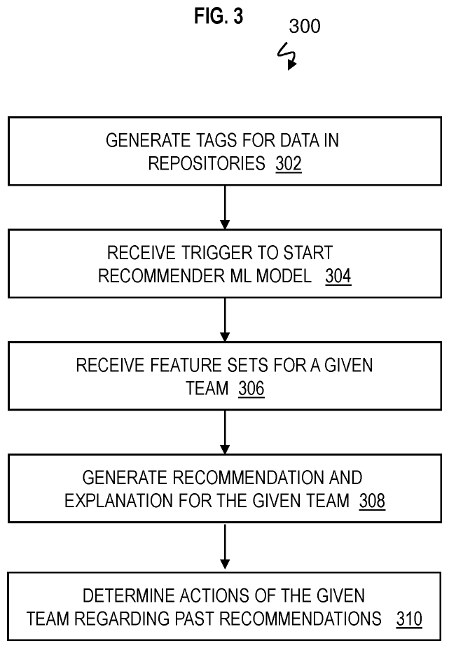

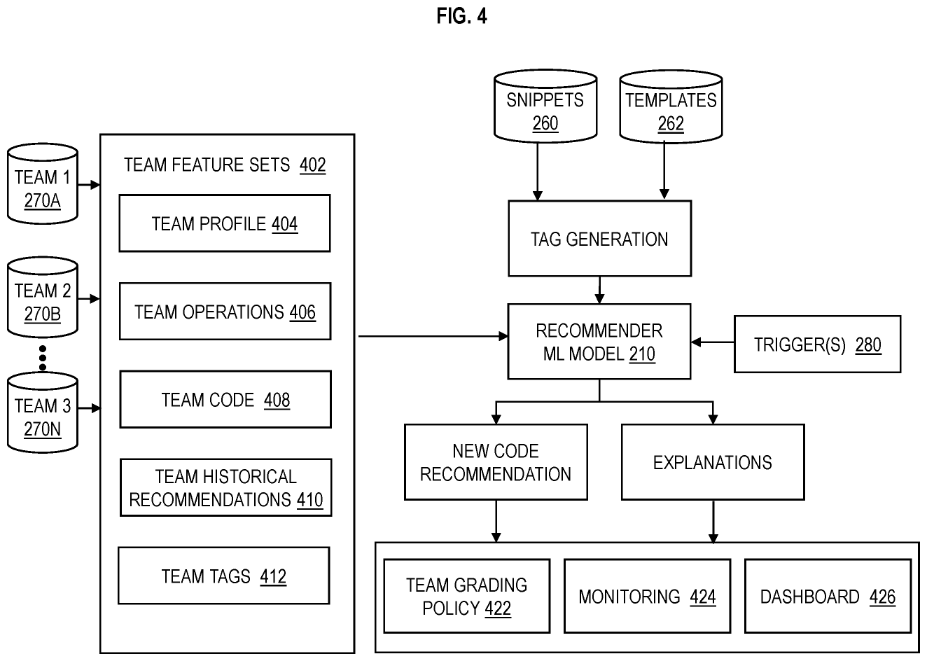

FIG. 3 is a flowchart of a computer-implemented method 300 for providing and utilizing a machine learning model for generating code snippets and templates for software development teams and for causing display of the code snippets on computer systems of a software development team to resolve a computer problem according to one or more embodiments. The computer-implemented method 300 is executed by the computer system 202. FIG. 4 depicts a block diagram of an example overview of providing and utilizing a machine learning model for generating code snippets and templates for software development teams and causing display of the code snippets on computer systems of a software development team to resolve a computer problem according to one or more embodiments. Reference can be made to any figures discussed herein.

Referring to FIG. 3, at block 302 of the computer-implemented method 300, one or more software applications 204 of computer system 202 are configured to generate and/or cause the generation of tags for the numerous standard code snippets in the repository 260 and tags for the numerous reference architecture templates in the repository 262. In information systems, a tag is a keyword or term assigned to a piece of information. This kind of metadata helps describe an item and allows it to be found again by browsing, searching, etc. The tags are utilized by the recommender machine learning model 210 to make a recommendation of the code snippets and templates associated with the respective tags.

At block 304, one or more software applications 204 of computer system 202 are configured to receive a trigger 280 to start/initialize the recommender machine learning model 210.

At block 306, one or more software applications 204 of computer system 202 are configured to receive feature sets for a given team, such as Team 1. The team feature sets are input to the recommender machine learning model 210 at the time the trigger 280 initiates the recommender machine learning model 210. There can be N teams, such as Teams 1, 2, and 3, and the respective data of Teams 1, 2, and 3 can be utilized to generate their respective feature sets. As depicted in FIG. 4, each of the teams has its own team feature sets illustrated as team feature sets 402. Team 1 has its own team feature sets 402, Team 2 has its own team feature sets 402, and Team 3 has its own team feature sets, all of which are different from team feature sets from one another. The team feature sets 402 for a given team can include a feature sets for team profile 404, team operations 406, team code 408, team historical recommendations 410, and team tags 412. In an example scenario, a given team can be Team 1 for explanation purposes but it should be appreciated that the description applies by analogy to each of the Teams 1, 2, and 3.

At block 308, one or more software applications 204 of computer system 202 are configured to cause, instruct, employ, and/or call the recommender machine learning model 210 to generate/recommend new recommendations of code snippets and/or reference architecture templates along with explanations, in response to the trigger 280.

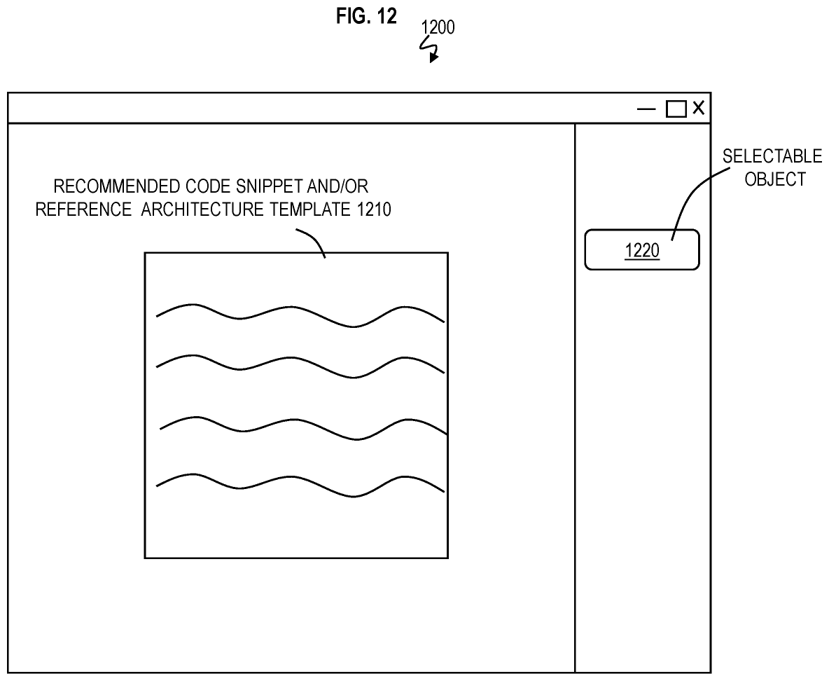

The computer system 202 can cause and/or instruct one or more computer systems 240 to display the recommended code snippet. In one or more embodiments, the computer system 202 can cause a graphical user interface (GUI) to be initiated on the computer systems 240 and display the recommended code snippet on the computer systems 240 of the software development team, as depicted in FIG. 12. In one or more embodiments, a selectable object 1220 can be displayed on the display 119 and selection of the selectable object causes the code snippet to be displayed for use on the computer systems 240 of the software development team, as depicted in FIG. 12.

Referring to FIG. 3, at block 310, one or more software applications 204 of computer system 202 are configured to determine actions associated with the given team regarding past recommendations from the recommender machine learning model 210. The computer system 202 can cause execution and/or implementation of a team grading policy 422, monitoring 424, and a dashboard 426. The team grading policy 422 generates a screen displaying a view of team grades for a given team. The monitoring 424 generates a screen displaying a view of code snippet coverage over time. The dashboard 426 generates a screen displaying a view of recommendations/actions taken per team.

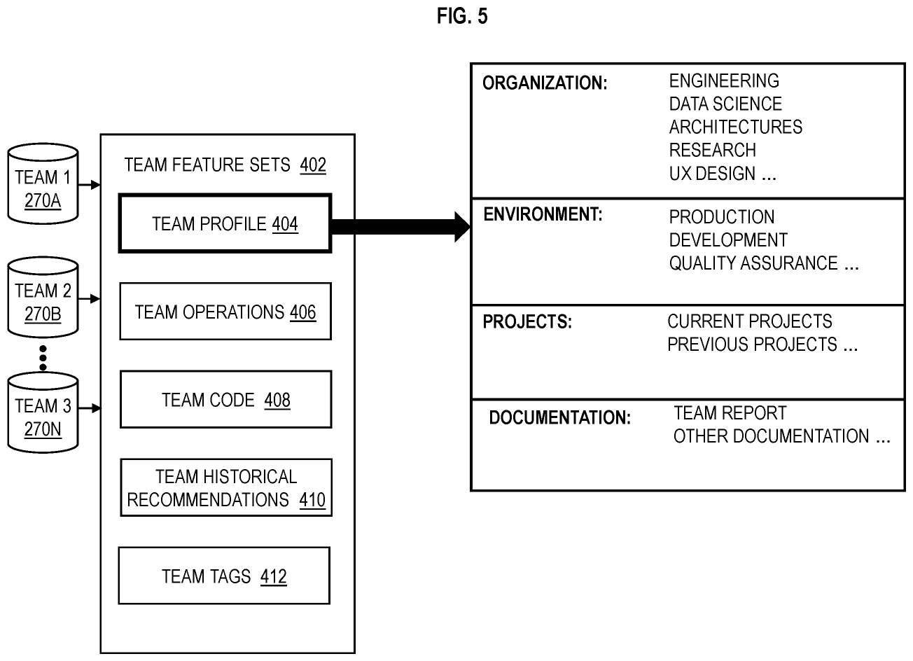

According to one or more embodiments, FIGS. 5, 6, 7, 8, and 9 depict further details regarding the team feature sets 402 for a given team according to one or more embodiments. A given team feature set is input to the recommender machine learning model 210 to generate a new recommendation. Additionally, the team feature sets 402 are also utilized as training data to train the recommender machine learning model 210 to generate new recommendations. Additionally, training data for the recommender machine learning model 210 can also include historical data of past standard code snippets, past reference architecture templates, and past triggers, along with the team feature sets 402 for each of the teams. Any such training data can be stored in a training data repository 206 for training the recommender machine learning model 210.

In one or more embodiments, one-hot encoding can be utilized for the feature sets, where values “1” or “0” can be utilized to respectively identify the presence or absence of a particular feature. One-hot encoding is a process of converting categorical data variables so they can be provided to machine learning algorithms, as understood by one of ordinary skill in the art. A feature set is a group of features that can be ingested together and stored in a logical group. Feature sets take data from sources, build a list of features through a set of transformations, and store the resulting features along with the associated metadata and statistics. Features of the feature sets may be included in a matrix or feature matrix. The feature matrix includes the features and their corresponding value or target values. In machine learning, a feature vector is an n-dimensional vector of numerical features that represent some object. Many algorithms in machine learning require a numerical representation of objects since such representations facilitate processing and statistical analysis.

FIG. 5 depicts a block diagram of example features for the team profile for a given team. The feature set of the team profile 404 can include organization, environment, projects, documentation, etc., where each can be a feature vector. Features of the feature vector for the organization can include engineering, data science, architectures, research, user experience, etc. Features of the feature vector for environment can include production, development, quality assurance (QA), etc. Features of the feature vector for projects can include current projects (e.g., what kind of projects), previous projects, etc. Features of the feature vector for documentation can include the reports of the team, other documentation, etc.

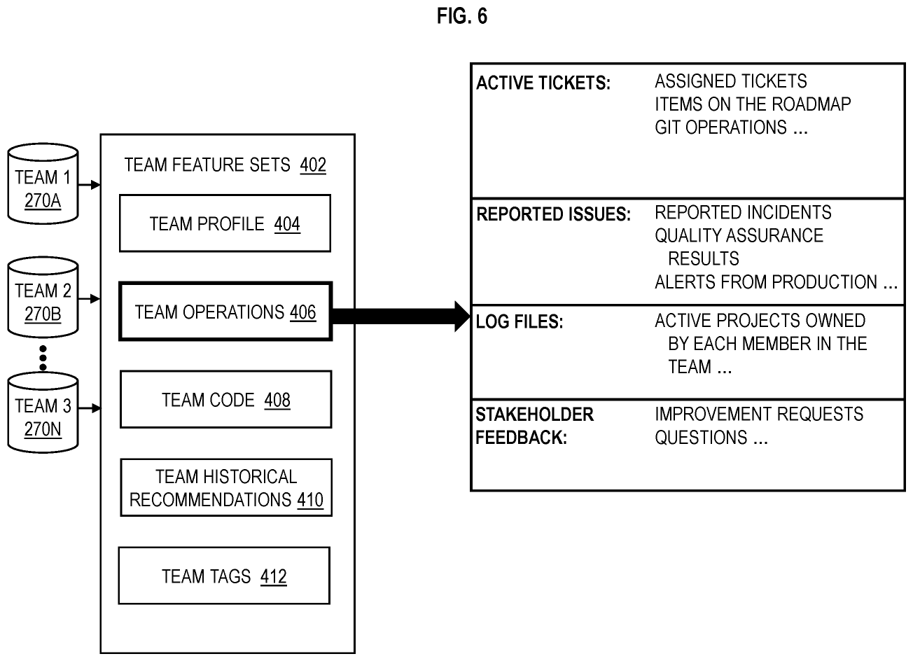

FIG. 6 depicts a block diagram of example features for team operations for a given team. The feature set of the team operations 406 can include active tickets, reported issues, log files, stakeholder feedback, etc., where each can be a feature vector. Features of the feature vector for the active tickets include assigned tickets, items on the roadmap, Git operations, etc. Git is a software platform mainly used by computer programmers for collaboration, and Git keeps track of changes to files and allows multiple users to coordinate updates to those files. Features of the feature vector for the reported issues include reported incidents, quality assurance results, alerts from production, etc. The reported incidents can identify that something failed, for example, a database (e.g., MongoDB® database) has a connection problem. Also, the reported incidents can indicate that the given team is working on an issue, working on a particular type of problem, etc. Features of the feature vector for the log files can include active projects owned by each member in the team, etc. Features of the feature vector for the stakeholder feedback can include improvement requests, questions, etc. The stakeholder feedback can be for the future. In one or more embodiments, the stakeholder feedback could act as a trigger 280 that initiates the recommender machine learning model 210.

An information technology (IT) ticketing system is a tool used to track IT service change requests, events, incidents, and alerts that might require additional action from the IT department. Ticketing software allows organizations to resolve their internal IT issues by streamlining the resolution process. The elements they manage, called tickets, provide context about the issues including details, categories, and any relevant tags. The ticket often contains additional contextual details and may also include relevant contact information of the individual who created the ticket. Tickets are usually employee-generated, but automated tickets may also be created when specific incidents occur and are flagged. Once a ticket is created, it is assigned to an IT team to be resolved. Effective ticketing systems allow tickets to be submitted via a variety of methods.

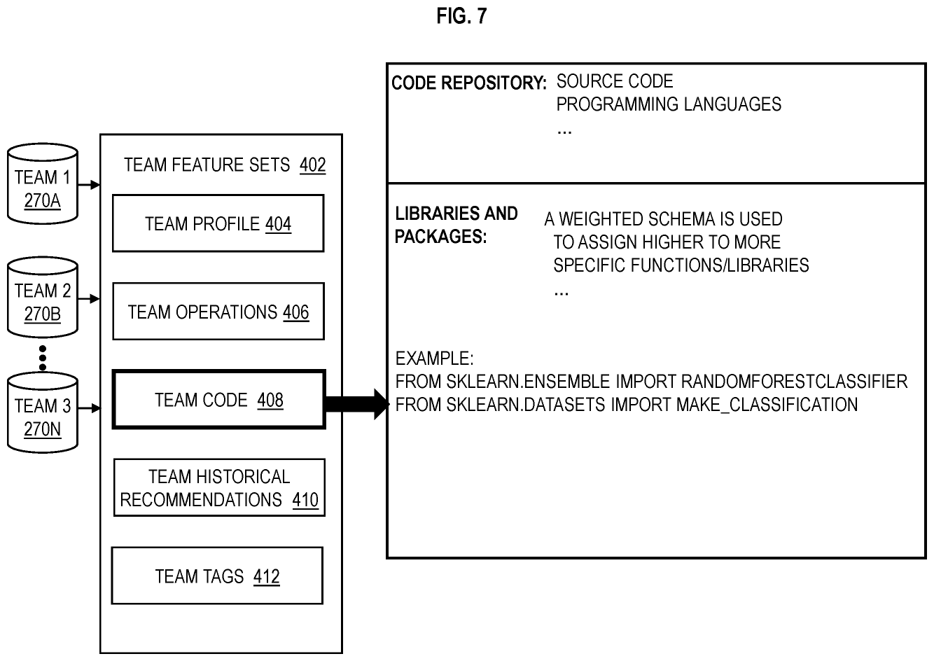

FIG. 7 depicts a block diagram of example features for team code for a given team. The feature set of the team code 408 can include code repository, libraries, packages, etc., where each can be a feature vector. Features of the feature vector for the code repository can include source code, programming languages, etc. Features of the feature vector for the libraries and packages can include a weighted schema utilized to assign a higher weight to more specific functions/libraries. The software applications 204 can utilize a frequency-based factor to assign weights to the libraries and packages. An example frequency-based algorithm can include term frequency inverse document frequency (TF_IDF) which is an algorithm that uses the frequency of words to determine how relevant those words are to a given document. An example of a library and package combination has the form from “library” import “package” and can include, for example, from sklearn.ensemble import RandomForestClassifier. Another example of a library and package combination can include, for example, from sklearn.datasets import make_classification.

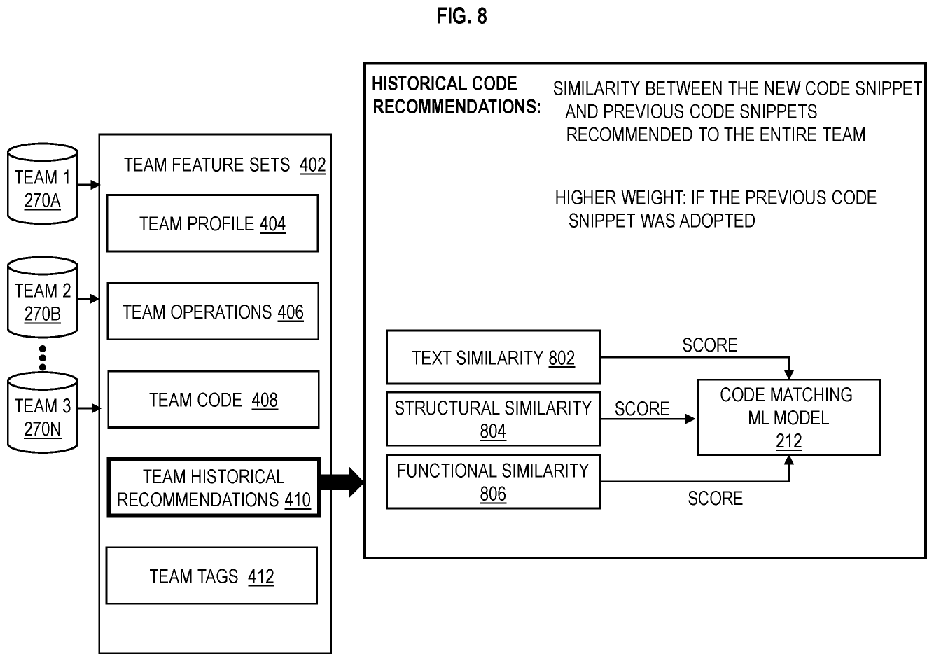

FIG. 8 depicts a block diagram of example features for team historical recommendations for a given team. The feature set of the team historical recommendations 410 can include historical code recommendations, etc., where each can be a feature vector. Features of the feature vector for the team historical recommendations 410 are utilized to find the similarity between the new code snippet recently added to the repository 260 and previous code snippets recommended to the entire team, where the new code snippet just added to the repository 260 can act as a trigger 280. A higher weight is provided when the previous code snippet is adopted by the team. Also, the feature set of the team historical recommendations 410 can include the output (e.g., score) of a text similarity model 802, the output (e.g., score) of a structural similarity model 804, and the output (e.g., score) of a functional similarity model 806 where each of the outputs are provided to the code matching machine learning model 212.

The text similarity model 802 can utilize (fuzzy) matching techniques, deep learning methods, etc., for text matching between the new code snippet recently added to the repository 260 and previous code snippets already recommended to the entire team. The text similarity model 802 parses the text of the code to find similarity.

The structural similarity model 804 can make comparisons between data structures of the new code snippet recently added to the repository 260 and previous code snippets already recommended to the entire team. The structural similarity model 804 can make comparisons between the inputs and outputs of the new code snippet recently added to the repository 260 and the inputs and outputs of previous code snippets already recommended to the entire team. For example, the structural similarity model 804 can compare structural line pointers between the new code snippet recently added to the repository 260 and previous code snippets already recommended to the entire team in order to determine similarity.

The functional similarity model 806 can make comparisons for the libraries and packages used between the new code snippet recently added to the repository 260 and previous code snippets already recommended to the entire team in order to determine similarity. The functional similarity model 806 can make comparisons of operations and their sequences between the new code snippet recently added to the repository 260 and previous code snippets already recommended to the entire team in order to determine similarity. The functional similarity model 806 parses operations like supply, predict, evaluations, etc., for the given team. By comparing the new code snippet recently added to the repository 260 and previous code snippets already recommended to the entire team, similarities can be found there is use of the same/similar libraries, packages, operations, and sequences of the operations, thereby determining that the new code snippet recently added and previous code snippets already recommended are functionality similar.

Scores are provided to the code matching machine learning model 212 from the text similarity model 802, the structural similarity model 804, and the functional similarity model 806 in order to determine whether the new code snippet recently added to the repository 260 and any previous code snippets already recommended are similar. The code matching machine learning model 212 has been trained on training data of (past) scores from the similarity model 802, the structural similarity model 804, and the functional similarity model 806 in order to classify a new code snippet as a match (e.g., equal to or greater than a confidence score) to any previous code snippets already recommended. During training, the training data can be prelabeled when the scores for the new code snippet is classified as a match or classified as no match.

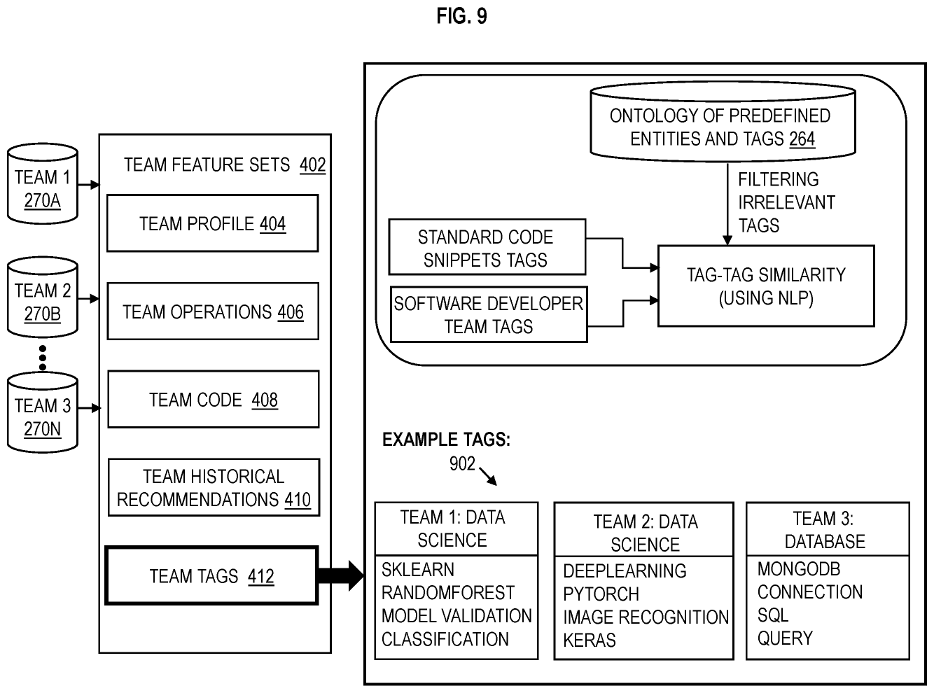

FIG. 9 depicts a block diagram of example features for team tags for a given team. The feature set of the team tags 412 can include standard code snippet tags, software developer team tags, and an ontology of predefined entities and tags of repository 264. The ontology of predefined entities and tags of the repository 264 can include entities like, for example, particular software development teams, application of business services being created, the team members (people, identification numbers, etc.) working on a service being provided, etc. The standard code snippet tags are tags that identify the code snippets stored in the repository 260. The software developer team tags are tags that identify and characterize the given software development team. Some tags of the software developer team tags can be developer driven. To determine a similarity, the tag associated with the trigger 280 such as the new code snippet is compared with the standard code snippet tags, software developer team tags, and/or ontology of predefined entities and tags of the repository 264. In one or more embodiments, the tag-to-tag similarity can be determined using natural language processing (NLP), rules-based logic, etc.

For illustration purposes, example team tags 902 are illustrated in FIG. 9. Team 1 may have a data science tag and include further tags such as sklearn, random forest, model validation, classification, etc. Team 1 may have a data science tag and include further tags such as deep learning, pytorch, image recognition, keras, etc. Team 3 could may a database tag and include further tags such as MongoDB®, connection, SQL, query, etc.

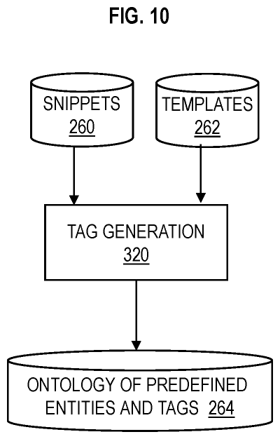

FIG. 10 depicts a block diagram illustrating further details regarding tag generation. The tags generated for the repository 264 of the ontology of predefined entities and tags can be developer driven and data driven. For developer-driven tags, software developers can add tags to the standard code snippets in repository 260 and to the reference architecture templates in repository 262 in order to help other teams discover them, for example, using the recommender machine learning model 210. Developer-driven tags can include any relevant keywords from the ontology regardless of how many times they occur in the corresponding code and/or corresponding templates.

Data-driven tags include keywords that can identify a code snipper and/or reference architecture template using NLP techniques such as TF-IDF, using abbreviations, etc. For data-driven tags, special keywords could be added as tags such as library and package names, functions names, main entities extracted from a design document (Amazon Web Services®, virtual machine, MongoDB®, etc.), etc.

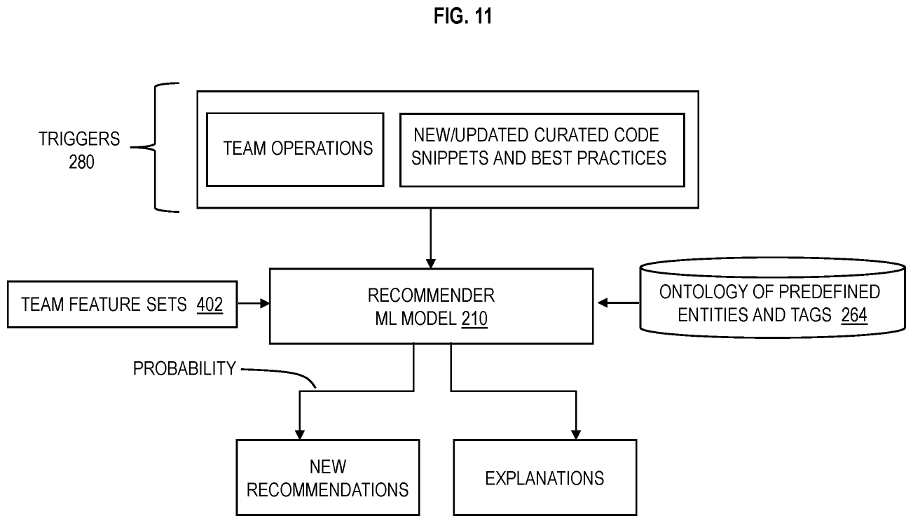

FIG. 11 depicts a block diagram illustrating further details regarding generating recommendations. As discussed herein, the software applications 204 can receive one or more triggers 280 for initiating the recommender machine learning model 210 on computer system 202. The triggers 280 to execute the recommender machine learning model 210 can include team operations and new/updated corrected code snippets and best practices. New and/or updated curated code snippets and best practices can be added to the repository 260, and the addition of the new and/or updated code snippets can trigger the execution of the recommender machine learning model 210.

The team operations as triggers 280 can include Git operations such as when a team uploads their code snippet to the repository 260. The team operations as triggers 280 can include reported issues, for example, receiving a ticket, reporting an issue that the team is working on (e.g., a user interface problem), providing a task to the team, etc. The team operations as triggers 280 can include an update to a log file, which could be an update to software, a system, a database, etc. Also, the team operations as triggers 280 can include stakeholder feedback, which may be requests, identification of problems, changes, software products requested in the future, etc.

The team feature sets 402 for a given team are input to the recommender machine learning model 210, and the recommender machine learning model 210 accesses the repository 264 of the ontology of predefined entities and tags. The recommender machine learning model 210 generates the recommendation as a code snippet from repository 260 and/or a reference architecture template from repository 262, along with an explanation of why the recommendation was made.

A recommendation for a given team does not include only the standard code for example, but also, the related architecture template such as an architecture design, user experience design, and documentation if available. When the recommendation is an architecture template, the corresponding code snippet and other related items are included in the recommendation offered to the given team. For a given software development team, the recommendation can include the following: [team name, <standard code snippetⱼ, reference architecture templateᵢ>], where “j” can represent a name or identification number of the standard code snippet in the repository 260 and where “i” can represent a name or identification number of the reference architecture template in the repository 262. There can be more than one standard code snippet recommended and/or more than one reference architecture template recommended at a time, for a given team. For each recommendation, a probability or confidence score is provided for how likely the recommendation, for example, code snippet is relevant to the given team.

All of the team feature sets 402 discussed herein are fed to the recommender machine learning model 210 to predict the relevance score (probability) of a particular code snippet and/or reference architecture template for a given team at a given point of time. In addition to the probability of relevance for a given team, the recommender machine learning model 210 identifies which feature contributed the most to the decision, such as, for example, the reported incident, a very high similarity score to an older recommendation adopted by this team, etc. These types of explanations help the team trust the recommender machine learning model 210 and understand why the team received the recommendation.

Both the code snippet and reference architecture template are part of the recommendation sent to the computer systems 240 from which the team members can select to use. For example, the software development team can select in a graphical user interface to use code snippet, the reference architecture template, and/or both, and the selection is provided to the software applications 204 for tracking. Also, a feedback loop can be added to the training dataset, where adoption is denoted by 1 and dismiss or no adoption is denoted by 0.

As discussed in FIG. 4, the software applications 204 can include, employ, and/or call on software for execution of the team grading policy 422, the monitoring 424, and the dashboard 426. The team grading policy 422 can be based on the code matching metrics including coverage and adoption. Teams can be ranked and graded “A”, “B”, “C”, and so forth. The grading system can be adjusted as needed, and the adjustments can be made as policies/rules by subject matter experts. Organizations can recognize high-performing teams, and at the same time identify opportunities to improve the quality of the software code for the remaining teams with targeted recommendations at the team level. The monitoring 424 includes identifying and recognizing top rated teams in terms of best practice code patterns (reuse). The monitoring 424 also includes identifying teams with poor code quality, and no actions taken after receiving the recommendations. The performance of teams can be illustrated over time in the dashboard 426. For example, user interfaces and graphs can be generated to view a team's grades and snippets coverage over time.

FIG. 12 depicts a block diagram of an example graphical user interface 1200 rendering recommendations for a given team on the computer systems 240 according to one or more embodiments of the present invention. The software applications 204 have received a trigger 280 that is utilized to start the recommender machine learning model 210. The team feature sets 402 are fed to the recommender machine learning model 210 for a given team in response to the trigger 280. The recommender machine learning model 210 is configured to generate a recommendation for the given team. In the example scenario, the given team can be the software development Team 1. Accordingly, the unique team feature sets 402 for the software development Team 1 were utilized to generate the recommendation of code snippets from repository 260 and/or reference architecture templates from repository 262. As depicted in FIG. 12 and continuing the example scenario, the software applications 204 can cause a graphical user interface 1200 to be displayed on each of the computer systems 240A for the software development Team 1. Team 1 can have 1-M members respectively using computer systems 1-M of the computer systems 240A to cooperatively develop a software product. In FIG. 12, in response to the recommender machine learning model 210 generating the recommendation, software applications 204 can cause a recommendation to be displayed in the graphical user interface 1200 of the computer systems 240A as example recommended code snippet and/or reference architecture template 1210. Upon adoption of the recommendation, the recommended code snippet and/or reference architecture template 1210 is executed by a processor of one or more computer systems 290 to accomplish a predetermined computer executable task. In one or more embodiments, in response to the recommender machine learning model 210 generating the recommendation, software applications 204 can cause a selectable object 1220 to be displayed in the graphical user interface 1200 such that the selection of the selectable object 1220 causes display of the recommended code snippet and/or reference architecture template 1210. The computer systems 290 can be in a cloud computing environment.

By executing the recommended code snippet and/or reference architecture template 1210, one or more embodiments can diagnose, resolve, and fix computer performance issues. Moreover, correcting reported computer issues, avoiding software bugs, and/or fixing software bugs on a running computer system cannot be performed in the human mind with the assistance of pen/paper. Further, quickly recommending, providing, and/or executing the recommended code snippet and/or reference architecture template 1210 can block/prevent/address a malicious computer attack or intrusion, a computer security threat, a serious malfunction of software/hardware, etc., each of which could be very time sensitive and prevent further exposure the problem. Accordingly, one or more embodiments improve the functioning of a computer system itself as well as multiple computer systems interconnected in a cloud environment.

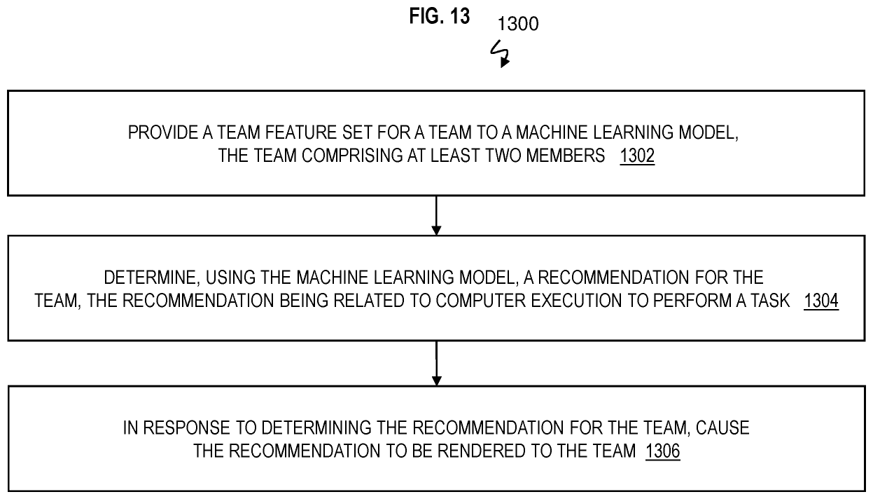

FIG. 13 is a flowchart of a computer-implemented method 300 for providing and utilizing a machine learning model for generating code snippets and templates for software development teams and for causing display of the code snippets on computer systems of a software development team to resolve a computer problem according to one or more embodiments.

At block 1302, the software applications 204 of computer system 202 are configured to provide a team feature set (e.g., team feature sets 402) for a team to a machine learning model (e.g., recommender machine learning model 210), the team comprising at least two members (e.g., 1-M). At block 1304, the software applications 204 are configured to determine, using the machine learning model (e.g., recommender machine learning model 210), a recommendation for the team, the recommendation being related to computer execution to perform a task. At block 1306, the software applications 204 are configured to, in response to determining the recommendation for the team, cause the recommendation to be rendered to the team.

The team feature set (e.g., team feature sets 402) includes attributes that characterize the team, the attributes accounting for the at least two members. Attributes relate to the features of the team feature sets 402 for a given team discussed in FIGS. 4-9.

The team feature set (e.g., team feature sets 402) characterizes the team (e.g., Team 1) and another team feature set (e.g., another team feature sets 402) characterizes another team (e.g., Team 2); and the machine learning model (e.g., recommender machine learning model 210) is configured to determine another recommendation specific for the another team (e.g., Team 2) in accordance with the another team feature set.

The machine learning model is initiated based on a trigger (e.g., trigger 280), the trigger being related to at least one of team operations (e.g., active tickets for the given team, reported issues for the given team, log files for the given team, stakeholder feedback for the given team) a new code snippet uploaded to the repository 260, an updated code snippet that is updated in the repository 260, a new reference architecture template uploaded to the repository 262, and updated architecture template that is updated in the repository 262.

The recommendation includes at least one of a code snippet from the repository 260 and a reference architecture template from the repository 262. Causing the recommendation to be rendered to the team includes causing the recommendation to display in a graphical user interface (e.g., graphical user interface 1200) for the team. A code snippet of the recommendation is configured to be executed by a processor to perform the task on a computer, for example, executed in a software product by the computer system 290.

In one or more embodiments, machine learning models discussed herein (including the recommender machine learning model 210, the code matching machine learning model 212, etc.) can include various engines/classifiers and/or can be implemented on a neural network. The features of the engines/classifiers can be implemented by configuring and arranging the computer system 202 to execute machine learning algorithms. In general, machine learning algorithms, in effect, extract features from received data (e.g., the complete message formed of segmented messages) in order to “classify” the received data. Examples of suitable classifiers include but are not limited to neural networks, support vector machines (SVMs), logistic regression, decision trees, hidden Markov Models (HMMs), etc. The end result of the classifier's operations, i.e., the “classification,” is to predict a class (or label) for the data. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In one or more embodiments, the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Training datasets (e.g., training data 206) can be utilized to train the machine learning algorithms. The training datasets can include historical data of past tickets and the corresponding options/suggestions/resolutions provided for the respective tickets. Labels of options/suggestions can be applied to respective tickets to train the machine learning algorithms, as part of supervised learning. For the preprocessing, the raw training datasets may be collected and sorted manually. The sorted dataset may be labeled (e.g., using the Amazon Web Services® (AWS®) labeling tool such as Amazon SageMaker® Ground Truth). The training dataset may be divided into training, testing, and validation datasets. Training and validation datasets are used for training and evaluation, while the testing dataset is used after training to test the machine learning model on an unseen dataset. The training dataset may be processed through different data augmentation techniques. Training takes the labeled datasets, base networks, loss functions, and hyperparameters, and once these are all created and compiled, the training of the neural network occurs to eventually result in the trained machine learning model (e.g., trained machine learning algorithms). Once the model is trained, the model (including the adjusted weights) is saved to a file for deployment and/or further testing on the test dataset.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 14, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 14 are intended to be illustrative only and that computing nodes 10 and cloud computing environment 50 can communicate with any type of computerized device over any type of network and/or network addressable connection (e.g., using a web browser).

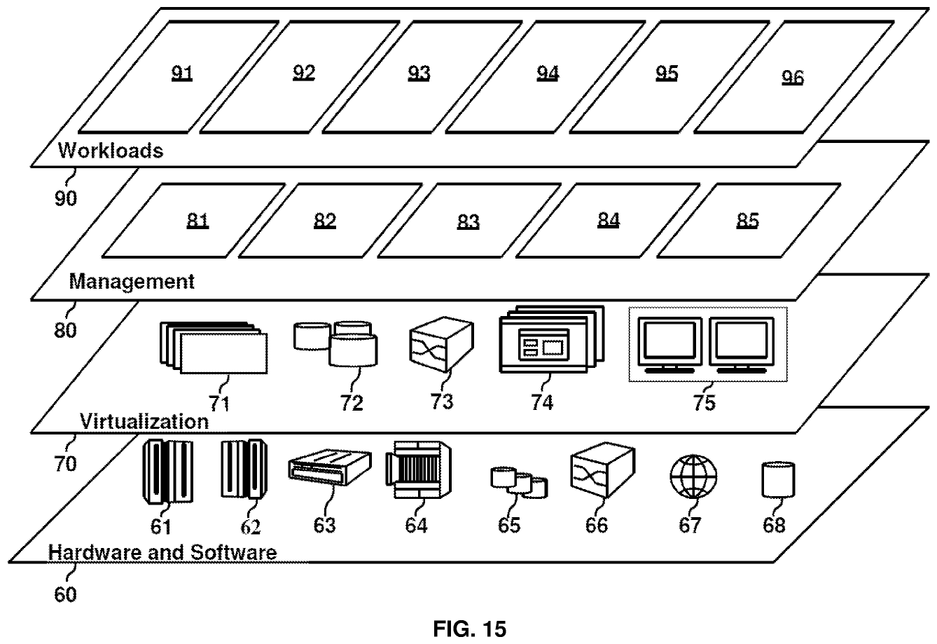

Referring now to FIG. 15, a set of functional abstraction layers provided by cloud computing environment 50 (depicted in FIG. 14) is shown. It should be understood in advance that the components, layers, and functions shown in FIG. 15 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of #8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
providing a team feature set for a team to a machine learning model, the team comprising at least two members;
determining, using the machine learning model, a recommendation for the team, the recommendation being related to computer execution to perform a task; and
in response to determining the recommendation for the team, causing the recommendation to be rendered to the team.

2. The computer-implemented method of claim 1, wherein the team feature set comprises attributes that characterize the team, the attributes accounting for the at least two members.

3. The computer-implemented method of claim 1, wherein:
the team feature set characterizes the team and another team feature set characterizes another team; and
the machine learning model is configured to determine another recommendation for the another team in accordance with the another team feature set.

4. The computer-implemented method of claim 1, wherein the machine learning model is initiated based on a trigger, the trigger being related to at least one of team operations, a new code snippet, an updated code snippet, a new reference architecture template, and updated architecture template.

5. The computer-implemented method of claim 1, wherein the recommendation comprises at least one of a code snippet and a reference architecture template.

6. The computer-implemented method of claim 1, wherein causing the recommendation to be rendered to the team comprises causing the recommendation to display in a graphical user interface for the team.

7. The computer-implemented method of claim 1, wherein a code snippet of the recommendation is configured to be executed by a processor to perform the task on a computer.

8. A system comprising:
a memory having computer readable instructions; and
one or more processors for executing the computer readable instructions, the computer readable instructions controlling the one or more processors to perform operations comprising:
providing a team feature set for a team to a machine learning model, the team comprising at least two members;
determining, using the machine learning model, a recommendation for the team, the recommendation being related to computer execution to perform a task; and
in response to determining the recommendation for the team, causing the recommendation to be rendered to the team.

9. The system of claim 8, wherein the team feature set comprises attributes that characterize the team, the attributes accounting for the at least two members.

10. The system of claim 8, wherein:
the team feature set characterizes the team and another team feature set characterizes another team; and
the machine learning model is configured to determine another recommendation for the another team in accordance with the another team feature set.

11. The system of claim 8, wherein the machine learning model is initiated based on a trigger, the trigger being related to at least one of team operations, a new code snippet, an updated code snippet, a new reference architecture template, and updated architecture template.

12. The system of claim 8, wherein the recommendation comprises at least one of a code snippet and a reference architecture template.

13. The system of claim 8, wherein causing the recommendation to be rendered to the team comprises causing the recommendation to display in a graphical user interface for the team.

14. The system of claim 8, wherein a code snippet of the recommendation is configured to be executed by a processor to perform the task on a computer.

15. A computer program product comprising a computer readable storage medium having program instructions embodied therewith, the program instructions executable by one or more processors to cause the one or more processors to perform operations comprising:
providing a team feature set for a team to a machine learning model, the team comprising at least two members;
determining, using the machine learning model, a recommendation for the team, the recommendation being related to computer execution to perform a task; and
in response to determining the recommendation for the team, causing the recommendation to be rendered to the team.

16. The computer program product of claim 15, wherein the team feature set comprises attributes that characterize the team, the attributes accounting for the at least two members.

17. The computer program product of claim 15, wherein:
the team feature set characterizes the team and another team feature set characterizes another team; and
the machine learning model is configured to determine another recommendation for the another team in accordance with the another team feature set.

18. The computer program product of claim 15, wherein the machine learning model is initiated based on a trigger, the trigger being related to at least one of team operations, a new code snippet, an updated code snippet, a new reference architecture template, and updated architecture template.

19. The computer program product of claim 15, wherein the recommendation comprises at least one of a code snippet and a reference architecture template.

20. The computer program product of claim 15, wherein causing the recommendation to be rendered to the team comprises causing the recommendation to display in a graphical user interface for the team.
